(19) United States
(12) Patent Application Publication
(10) Pub. No.: US 2014/0248658 A1
(43) Pub. Date: Sep. 4, 2014

(54) CYTOPLASMIC STAIN COMPOSITION

(71) Applicant: HCI SCIENCES, LLC, Minden, NV (US)

(72) Inventor: Jerry Fredenburgh, Carson City, NV (US)

(73) Assignee: HCI SCIENCES, LLC, Minden, NV (US)

(21) Appl. No.: 13/781,944

(22) Filed: Mar. 1, 2013

(51) Int. Cl. G01N 1/30

(52) U.S. Cl. CPC G01N 1/30
USPC 435/40.5

(57) ABSTRACT

A composition of two cytoplasm stains for use in differentiation of cell nuclei from cell cytoplasmic components and differentiation of specific cytoplasm components by tinctorial contrast. Specifically, the invention relates to two stain compositions utilized as a counter stain in the hematoxylin and eosin procedure for use in histological and cytological microscopic evaluation of tissue and cells. In one embodiment, the composition includes eosin-Y as the sole dye in the composition, and a propylene glycol solvent and an organic buffer. In another embodiment, the composition includes a mixture of eosin-Y and phloxine-B as the sole dye, also in a propylene glycol solvent and an organic buffer.

### BACKGROUND OF THE INVENTION

The present invention relates to the field of biological stains and compositions useful for producing such stains. Specifically, the invention relates to cytoplasmic stains utilized in the hematoxylin and eosin staining technique for use in histology and cytology. In the hematoxylin and eosin technique, the cytoplasmic stain is referred to as the counter stain.

The composition of the present invention is used to provide differentiating contrast between nuclei/nuclear chromatin and cytoplasm. Tinctorial differentiation of specific cytoplasmic elements is also demonstrated. The invention is most generally used in the hematoxylin and eosin staining procedure but is not limited to this procedure alone.

In the preparation of histology and cytology tissue and cell samples for microscopic analysis, dyes have been used to stain tissues, cells, and cell components to facilitate their examination with light microscopy. The dyes stain cellular components with different tinctorial colors, differentiating the cell components. Therefore, stains are employed to differentiate cell components chromatically.

Staining solutions such as eosin and phloxine eosin have been used for some time with satisfactory results, although there has been a need for stains possessing greater transparency and clarity. In particular, when acid dye staining solutions such as eosin-Y, or phloxine-B combined with eosin-Y, are used as cytoplasmic chromogen markers, there is at times an evident lack of cytoplasmic discrimination. Such condition is commonly referred to as muddy cytoplasm staining. The lack of discrimination is in part due to the pH of the staining solution.

Eosin-Y and phloxine-B are the sodium salts of an acid dye complex containing color. Eosin-Y and phloxine-B have a chromophore located in the anionic part of their molecule. Eosin-Y and phloxine-B are fully charged at about pH 7. The IEP of cytoplasmic protein is approximately pH 6. Thus, cytoplasmic staining must occur below pH 6 to obtain a net cationic charge on cytoplasmic protein.

In staining solutions of eosin-Y and mixtures of eosin-Y and phloxine-B, the amount of charged dye ions in a staining solution below pH 4 will greatly decrease because eosin-Y and phloxine-B are converted to a free acid. The free acid moieties in a staining solution below pH 4 will nonspecifically bind to cell cytoplasm due to hydrogen bonding. When this occurs, the tissue section appears muddy with the loss of transparency, which is evident.

Staining solutions of a pH range of about pH 4.0-6.0 maintains a net cationic charge on cytoplasmic protein but does not allow for the free acid moiety that forms below pH 4.0. The buffer described in the invention herein maintains a desirable pH range of 4.0-6.0 of the staining solution.

Traditional staining solutions of eosin-Y, and combinations of phloxine-B and eosin-Y, consist of an alcoholic solution of the dye or dyes where acetic acid has been added. The pH of traditional staining solutions varies with the number of slides processed though the staining solution, the age of the staining solution, and the amount of acetic acid added. In such traditional staining solutions, a buffer is not employed.

Traditional alcoholic solutions of eosin-Y and mixtures of phloxine-B and eosin-Y utilize ethyl alcohol or methyl alcohol as the dye solvent. The alcohol solvents allow for solvent evaporation which increases the dye content in the staining solution. An increase in dye concentration allows for tinctorial inconsistencies in cytoplasmic staining from day to day.

When a mixture of phloxine-B and eosin-Y is used as a cytoplasmic stain together, solvent evaporation may interfere with differentiation of specific cytoplasmic elements. Alcoholic solvents are also flammable, increasing the threat of a fire hazard in the laboratory. Hazardous shipping fees are also charged when these staining solutions are shipped via commercial transportation in containers of more than 1 liter. The use of propylene glycol as the dye solvent decreases the evaporation rate of the dye solvent, thus maintaining a more consistent dye concentration in the staining solution which results in a more consistent cytoplasmic stain from day to day.

### SUMMARY OF THE INVENTION

The present invention comprises biological cytoplasmic stains that provide more accurate staining of cytoplasmic elements of cells for microscopic analysis and/or study.

Stains prepared by the composition of this invention are pH stable, less hazardous, and more consistent in their day to day staining results than traditional eosin and phloxine eosin stains.

The stain composition of the present invention enables cytoplasm and specific cytoplasmic elements to be differentiated with consistent tinctorial results.

In one embodiment, the composition of the present invention includes eosin-Y as the sole dye, with an organic buffer in a propylene glycol solvent. In another embodiment, the composition of the present invention includes a mixture of eosin-Y and phloxine-B as the sole dye, also with an organic buffer in a propylene glycol solvent. The invention is generally used in the hematoxylin and eosin staining technique but is not limited to this procedure alone.

The principal objective of the present invention is to provide pH balanced cytoplasmic biological staining reagents that assure a consistent, clear and reproducible tinctorial cytoplasmic differentiation with the absence of muddy cytoplasm staining when tissue fixation is proper.

Another principal objective is to provide cytoplasmic differentiation with the aforesaid buffered glycol eosin-Y staining reagent resulting in cytoplasm staining of various shades of pink; collagen pink, muscle fibers deep pink, red blood cells orange/red, fibrin deep pink, and when prominent nucleoli are present in properly fixed cells, the nucleoli will stain red.

It is another principal objective to provide cytoplasmic differentiation with the aforesaid buffered glycol phloxine eosin staining reagent resulting in a more dramatic tinctorial cytoplasmic differentiation than eosin staining alone. For example, muscle fibers stain a deep pink to red when compared to collagen staining of pink. When prominent nucleoli are present in properly fixed cells, the nucleoli will stain red.

It is a further principal objective that the invention can be used in the same manner as traditional alcoholic eosin stains and traditional alcoholic phloxine eosin stains to stain and differentiate cytoplasm and/or used as a counter stain with the hematoxylin and eosin staining technique.

It is another objective to provide buffered cytoplasmic biological staining reagents that assure longer shelf-life without a shift in pH which has a definite impact on cytoplasmic staining quality.

A further objective is to provide a non-flammable staining reagent to decrease physical hazards in the laboratory.

It is yet a further objective to provide a non-flammable staining reagent that can be used on auto-stainers as well as hand staining.

It is still a further objective to eliminate hazardous shipping charges of products packaged in containers over 1 liter.

The reader skilled in the art will recognize other objects and advantages of the present invention, from a reading of the following detailed description of the invention, and the appended claims.

### DETAILED DESCRIPTION OF THE INVENTION

The composition of the present invention comprises two staining reagents that provide a more accurate, clear and reproducible staining of biological tissue samples and cells that relate to cytoplasm, various cytoplasmic elements, erythrocytes, eosinophilic granules, and other tissue elements with the exception of nuclear chromatin. Nuclear chromatin is traditionally stained with a hematoxylin solution; the present invention is used to produce counter stains with nuclear stains such as hematoxylin to allow for cell nuclei differentiation from cytoplasmic components. The composition of the present invention comprises staining components (dyes), a buffer, and a solvent.

The invention comprises a composition including two cytoplasmic counterstaining reagents. In a first embodiment, the composition is made by mixing a propylene glycol solvent, eosin-Y, and a buffer, stirring the mixture until the eosin-y is completely dissolved, and then filtering the mixture. In a second embodiment, the composition is made by mixing a propylene glycol solvent, eosin-Y, phloxine-B, and a buffer, stirring the mixture until the eosin-Y, and phloxine-B are completely dissolved, and then filtering the mixture.

In both embodiments, the eosin-Y, or the combination of eosin-Y and phloxine-B, comprises the only dye in the composition.

In a first preferred embodiment, the composition of the present invention comprises a mixture which includes an equivalent amount of one liter of 60% (by volume) propylene glycol (where the diluent in the lesser concentrations is water) buffered with 0.2M acetate buffer to a pH range of 4.6 to 5.0, and 5.0 grams of eosin-Y, where the eosin-Y dye concentration has been corrected to 100% dye content. The eosin-Y is present in a concentration of about 0.1%-2%, by weight.

In a second preferred embodiment, the composition of the present invention comprises a mixture which includes an equivalent amount of one liter of 60% propylene glycol (where the diluent in the lesser concentrations is water), buffered with 0.2M acetate buffer to a pH range of 4.6 to 5.0, and 11 grams of eosin-Y, where the eosin-Y dye concentration has been corrected to 100% dye content, and 1.12 grams of phloxine B, where the phloxine B dye concentration has been corrected to 100% dye content. Both the eosin-Y and the phloxine B are present in concentrations of about 0.1%-2%, by weight.

The buffer used in the propylene glycol solvent in both of the above-described embodiments is a modified 0.2 molar acetate buffer consisting of sodium acetate/acetic acid. The buffer was modified in such a way that the 60% propylene glycol solvent was used as the buffer solvent as well as the dye solvent.

The above-described modification of the traditional acetate buffer is as follows: 150 mL of 0.2M sodium acetate in 60% propylene; 850 mL of 0.2M glycol propylene glycol, resulting in a pH range of about pH 4.7. The traditional 0.2 acetate buffer in water was not found to be an acceptable buffer, due to the volume of buffer necessary to maintain the desired pH range, and the necessity to increase the molarity of the buffer solutions to achieve the desired pH range. An increase in molarity may result in an undesirable increase in osmolality resulting in cell artifacts.

An acetate buffer was chosen as the preferred buffer. It is an organic buffer that does not precipitate in solutions of propylene glycol or alcohols. Inorganic buffers, such as a phosphate buffer, may precipitate during tissue dehydration or storage of the staining reagent. The use of an inorganic buffer in conjunction with a dye solvent would also present a precipitate issue during dehydration of a stained tissue section. Inorganic buffers have little solubility in traditional dehydrating reagents (alcohol).

Traditionally, when tissue sections are stained with a cytoplasmic stain (counter stain), the staining process is followed by alcoholic solutions to remove excess cytoplasmic stain and to dehydrate the tissue section. As discussed herein an inorganic buffer would precipitate causing microscopic artifacts, where an organic buffer would be miscible with both propylene glycol and alcohols.

As discussed herein the traditional use of alcoholic staining solutions of eosin-Y, and phloxine-B and eosin-Y, pose a flammable hazard in laboratories. The staining of tissue sections and cells for microscopic examination and analysis is conducted in open containers of the said staining solutions; this is inclusive of manual staining and auto-staining. The use of non-flammable propylene glycol as the staining solvent eliminates the flammable hazards in laboratories. Also, propylene glycol possesses a solubility factor that allows for a low pH 4.0-5.0 without eosin-Y or a mixture of eosin-y and phloxine-B precipitating.

Propylene glycol was chosen over other glycols such as ethylene glycol (antifreeze) due to its non-toxic quality and low environmental impact. Ethylene glycol (antifreeze) may be substituted for propylene glycol in various aqueous mixtures or used alone, but would pose greater health and environmental impacts.

Also discussed herein is the use of a modified acetate buffer to lock in the pH range of the staining solution of eosin-Y, or phloxine-B and eosin-Y, to assure consistent reproducible staining results. More specifically, the buffered pH range of 4.6 to 5.0 of the staining solution assures a cationic charge on cytoplasmic proteins to allow for the staining results of the anionic dyes eosin-Y, or phloxine-B and eosin-Y, to be consistently reproducible, with the absence of a muddy staining result when the tissue has under gone proper fixation.

Other formulations of the composition of the present invention are possible, with different percentages of propylene glycol. It has been found that when the concentration of propylene glycol is in the range of about 45-100% (glycol content), by volume, the eosin will still be soluble. The choice of 60% as the preferred solvent concentration is based on desirable diffusion rates. However, a range of 45-100% glycol will still produce desirable results.

In general, other glycols or diols can be used as a solvent. The essential characteristics of such a solvent are 1) that the solvent be in liquid form, 2) that the solvent be non-flammable, and 3) that eosin-Y and phloxine-B must be soluble in the glycol solvent at a pH of about 4-6.

In the present invention, it is important to use an organic buffer, for the reasons given above.

The composition of the present invention has the advantage that it is a single staining solution which requires no mixing of components prior to use. The composition of the present invention is specifically intended for use in cytoplasmic staining.

The composition of the present invention has the advantage of using a propylene glycol solvent, as a dye solvent, in place of ethyl alcohol which is commonly used in staining solutions.

The composition of the present invention has the further advantage that it has a relatively long shelf life, and does not require mixing of components at the point of use. Thus, the composition can be prepared at a first location, and stored and/or transported, while still being ready for use at a later time.

The invention can be modified in various ways. For example, as indicated above, other solvents can be used instead of propylene glycol. Other organic buffers may also be used. These and other modifications, which should be apparent to those skilled in the art, should be considered within the spirit and scope of the following claims.

1. A stain composition comprising a mixture of eosin-Y in a solvent including a material selected from the group consisting of glycols and diols, and an organic buffer for maintaining the composition in a pH range of about 4.0-5.0, wherein the eosin-Y comprises a sole dye in said composition, and wherein the eosin-Y is soluble in said solvent throughout said pH range.

2. The stain composition of claim 1, wherein the solvent includes propylene glycol.

3. The stain composition of claim 2, wherein the propylene glycol is present in a concentration, by volume, of about 45% or greater.

4. The stain composition of claim 1, wherein the buffer comprises an acetate buffer.

5. The stain composition of claim 1, wherein the eosin-Y is present in a concentration of about 0.1%-2%, by weight, wherein a total dye content of the eosin-Y is corrected to 100%.

6. The stain composition of claim 1, wherein the solvent is selected from the group consisting of 100% propylene glycol, and a mixture of graded propylene glycol at 45% (by volume) or greater propylene glycol with the balance being water.

7. The stain composition of claim 1, wherein the buffer is of suitable molar strength to maintain the composition at a pH range of about 4.0-5.0.

8-15. (canceled)
